(19) United States
(12) Patent Application Publication
(10) Pub. No.: US 2008/0274042 A1
(43) Pub. Date: Nov. 6, 2008

(54) Nanostructured Zinc Oxide and a Method of Producing the Same

(75) Inventors: Kurnia Wira, Singapore (SG); Thim Choy Wong, Singapore (SG); Hengky N/a, Singapore (SG)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NANOSCIENCE INNOVATION PTE LTD.

(21) Appl. No.: 11/794,283

(22) PCT Filed: Dec. 28, 2005
(86) PCT No.: PCT/SG05/00432

§ 371 Date: Dec. 31, 2007

(30) Foreign Application Priority Data
Dec. 28, 2004 (SG) 200407791-3

(51) Int. Cl. C01G 9/03

(52) U.S. Cl. 423/623

(57) ABSTRACT

A method of producing nanostructured zinc oxide powder. The method comprises introducing a source of zinc selected from metallic zinc or zinc compound and a process gas mixture which includes an oxidizing gas (the reactants) into a reactor. While in the reactor, the reactants are heated to a process temperature effective to vaporize the zinc and to react the reactants to form a powder product. The powder product is recovered.

### TECHNICAL FIELD

The present invention relates to a method of producing zinc oxide particularly although not solely to a method of producing nanostructured zinc oxide powder.

### BACKGROUND

Zinc oxide has been used widely in paints, cosmetics, coatings, electronic devices, in resins and fibres. Many methods for producing zinc oxide are known and generally start from zinc metal as a starting material. Generally, there are two different processes of producing zinc oxide. They are the wet chemical process and the dry/gas phase chemical process.

The dry chemical processes typically use a heat source to vaporise metallic zinc powder. The vaporised zinc powder reacts with a process gas that contains essentially oxygen gas to form zinc oxide. The resultant zinc oxide is then cooled and collected. These processes generally fall within two areas:
a) the raw materials are preheated and placed into the heat source such as a furnace. The desired morphology of zinc oxide is produced with appropriate control of the environment. This is typically a batch process.
b) On-line pre-treatment of the raw materials and process gases which are then “injected” into the reactor to achieve the desired reaction. This is more likely a batch process also.

In some dry chemical processes, such as the one disclosed in U.S. Pat. No. 5,066,475, pretreatment of the metallic zinc powder, coating it with a layer of oxide film before thermally treating the surface oxidized powder in an environment containing molecular oxygen to produce whiskers and tetra-pod zinc oxide is required.

For complete oxidation to take place so as to avoid unreacted zinc from contaminating the final product, a desired temperature of the system has to be maintained. In some dry chemical processes, such as the one disclosed in EP 1215174, the desired temperature of the system is achieved and then maintained by use of several heaters. These heaters are required for different stages of the process. In this publication an inert gas first passes through a first heater to increase its temperature before it is fed into a vaporiser together with metallic zinc powder. The metallic zinc powder vaporises and the mixture of zinc vapor and the inert gas in the vaporiser is then transferred into another heater to further heat up the mixture. This mixture passes through a nozzle and is then injected into a reactor. At the same time, an oxidizing gas is heated in yet another heater before it is introduced into the reactor. The use of several heaters in this process is to ensure complete oxidation/reaction of the metallic zinc powder. It is also to ensure a continuous operation and to improve reaction speed. To increase heat conduction from the heater element to the raw material gas, thermally conducting media to promote heat conduction is employed in this prior art. However, the use of the thermally conducting media, which is in physical contact with the reactants, will increase potential impurity to the resultant product as more foreign materials are introduced.

In the above described process, vaporization and oxidation take place in different chambers. In such a system, maintaining a desired temperature of the system for complete vaporization and oxidation to take place may be difficult. One solution is to use several suitable heaters or heat maintaining apparatus to achieve or maintain the desired temperature. However, production costs tend to be higher due to the need to use several specialized heaters for the operation.

In JP 05097597, a combustion gas (heat source) generated from a combustion chamber is discharged into a reaction oven. The heat from the combustion gas vaporises the molten zinc that is fed into the reaction chamber. The vaporised zinc reacts with the combustion gas to form zinc oxide. In this process, vaporization and oxidation takes place in the same chamber. The temperature of the system is maintained by use of an reaction oven to supplement the insufficient heat produced by the combustion zone. However, due to the low temperature generated by the combustion gas the size of zinc oxide produced therefrom may not be of a desired nano size. Further, the combustion gases are a potential additional source of impurities.

### OBJECT OF THE INVENTION

It is accordingly an object of the present invention to provide a method of producing nanoscale zinc oxide which addresses the abovementioned disadvantages or which will at least provide the public with a useful choice.

### SUMMARY OF THE INVENTION

Accordingly in a first aspect the present invention consists in a method of preparing nanostructured zinc oxide powder comprising or including the steps of:
a. introducing a source of zinc selected from metallic zinc or a zinc compound and a process gas mixture which includes an oxidising gas (the reactants) into a reactor,
b. while in the reactor, heating the reactants to a process temperature effective to vaporise the zinc and to react the reactants to form a powder product, and
c. recovery of the powder product.

Preferably the method is a continuous process.

Preferably the process temperature is in the range 1200 K to 10,000 K.

Preferably the process temperature is in the range of 1500 K to 3800 K.

Preferably the source of zinc is metallic zinc.

Preferably the metallic zinc is selected from one or both of powdered zinc and zinc wire.

Preferably the metallic zinc is zinc powder and with an average particle size of between 1 mm to 1 micron.

Preferably the metallic zinc powder has an average particle size of substantially 5 microns.

Preferably the average zinc powder particle size is substantially 5 microns.

Preferably the oxidising gas contains at least an atom of oxygen, and its recombination potential is higher than the formation of ZnO.

Preferably the oxidising gas is oxygen.

Preferably the oxidising gas comprises between 5% and 95% by weight of the process gas mixture.

Preferably the oxidising gas comprises between 10% and 60% by weight of the process gas mixture.

Preferably the process gas mixture includes one or more of an inert gas and an assistive gas.

Preferably the process gas mixture, in addition to oxygen, includes argon and nitrogen and hydrogen.

Preferably the process gas mixture includes argon and air.

Preferably a heat source is used to heat the reactants to the process temperature.

Preferably the reactor includes the heat source.

Preferably the heat source is selected from one of gas-fuel combustion heat source, plasma heat source, hotbox, electrical arc.

Preferably the heat source is a plasma torch having one or more feed gas(es) and one or more plasma discharge gas(es), and one or more of the gases in the process gas mixture is at least a component of the one or more feed gas(es) and one or more plasma discharge gas(es) of the plasma torch.

Preferably vaporisation of the zinc, reaction of the reactants and initial cooling of the zinc oxide powder product take place in a single reactor chamber.

Preferably the reactor chamber includes an initial heating region where vaporisation of zinc occurs, a chemical reaction region where reaction of the reactants occurs to form zinc oxide, and a region where the zinc oxide powder product is cooled rapidly.

Preferably the recovery step includes filtering of the powder product and/or further cooling of the powder product.

Preferably the method includes a quenching step prior to the recovery step, which slows or stops the growth of the size of the particle product.

Preferably at least one dimension of the particle product has an average size between 10-3,000 nm.

Preferably at least one dimension of the particle product has an average size between 10-800 nm.

Preferably the morphology of the powder product is one or more of zero-, 1-, 2- and 3-dimensional.

Preferably the morphology of the powder product can be altered by alteration of one or more of the operating parameters of the process.

Preferably the operating parameters include one or more of:
a. identity of the process gas(es),
b. the power of the heat source,
c. the temperature of the heat source,
d. the process temperature,
e. the identity of the heat source,
f. the rate of cooling of the powder product.

According to a second aspect of the invention there is provided nanostructured zinc oxide powder prepared according to the method as described above.

Other aspects of the invention may become apparent from the following description which is given by way of example only and with reference to the accompanying drawings.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### DEFINITIONS

Where, in the specification, the following terms are used, they have the following meanings:
Powder A solid substance in the form of tiny loose particles that present in different size, morphology (shape), structure and surface texture. The particulates can be as fine as <10 nm and a coarse as >1-mm depending on the context; morphology & structure cover 0-D, 1-D 2-D & 3-D, solid to porous, crystalline to amorphous; surface texture can be from smooth, random and patented roughness.
Nanostructure An object measured with at least one of its dimensions on the nano-scale (on the order of 10-9) and/or object forms of nanoscale entities (ie the object itself and/or the fine element(s) that form the object being nanoscale in dimension.
Reactor By “reactor” we mean a chamber or other space suitable for housing the reactants during the method of the invention.
Assistive Gas By “assistive gas” we mean gases other than the fundamental process gas (such as the oxidizing gas), used for ensuring the smooth operation of the system.
Oxidising Gas By “oxidising gas” we mean a gas or gas mixture containing at least one atom of oxygen. The gas can be dissociated to free the oxygen atom for reaction

### BRIEF DESCRIPTION OF DRAWINGS

The invention will now be described with reference to the Figures in which:—

FIG. 1 illustrates a flow chart of the preferred method of the present invention;

FIG. 2 is a schematic view of an apparatus for continuously producing zinc oxide using a method according to the preferred embodiment of the present invention;

FIG. 3 is an electron micrograph of a zinc oxide whisker and tetrapod structure at 10,000 magnification prepared according to the method of the invention;

FIG. 4 is an electron micrograph of zinc oxide whisker and tetrapod structure at 70,000 magnification prepared according to the method of the invention;

FIG. 5 is an transmission electron micrograph on a leg of the multilegged zinc oxide product;

FIG. 6 is an example XRD spectrum of the zinc oxide powder product and comparison between the measured peaks and standard reference zinc oxide peaks, and

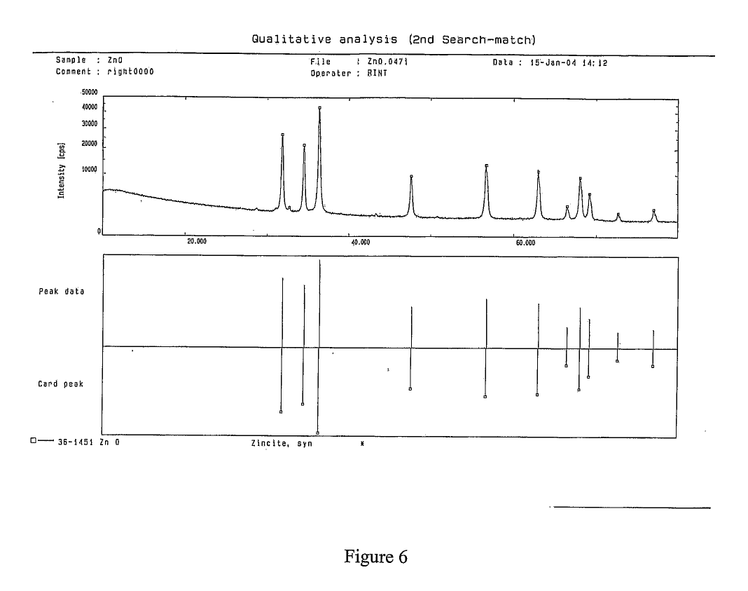

FIG. 7 is an electron micrograph of O-dimensional zinc oxide powder produced according to the method of the present invention. The structure is visible in the central portion of the micrograph which is in full focus.

### DETAILED DESCRIPTION

The current invention relates to a novel method of preparing zinc oxide powder which is nanostructured, and the product prepared according to the method.

The novelty particularly resides in the fact that this is a continuous production process where no materials pretreatment is required. No separate process is applied nor is there any requirement for separate chambers/stages of materials feed thereby allowing the use of a continuous process rather than batch. Thus our process bypasses various precursors processes which occur in the prior art. We directly feed the process materials, both solid and gases into the reactor without any material pretreatment.

Furthermore the method can produce large quantities of product. For example we have conservatively achieved a 6 kg/hr production rate of ZnO, and the product was nanostructured (20-30 nm structured diameter and 200-300 nm length). This is still operating at only half of the designed capacity.

### Method of the Invention

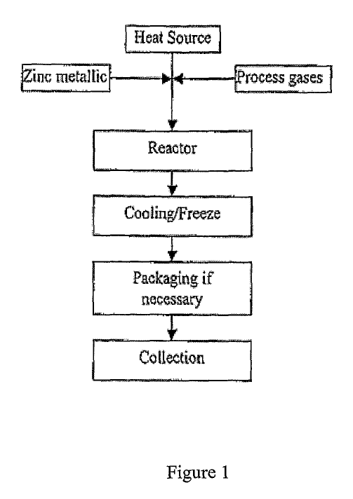

FIG. 1 illustrates a flowchart of the preferred process of the present invention. The general features of the novel method include as follows:

### a) Feed Materials.

The feed materials will include a source of zinc. The source of zinc may be metallic zinc, conveniently in the form of either wire or powder, or a zinc compound that can be converted into zinc ion during the reaction.

It is preferred that the source of zinc is metallic zinc. If powder is used the powder size can vary from a few microns to hundreds of microns. As would be envisaged by those skilled in the art, the invention also includes the situation where the metallic zinc includes a coating of carbonate which often forms on metallic zinc upon exposure to moist air.

Alternatively, the source of zinc may be a zinc compound capable of being converted into zinc ion. Examples of zinc compounds that may be used in the present invention include zinc chloride and zinc hydroxide.

### b) Processing Gases:

The essential feature of the processing gas(es) is that at least one oxidising gas is present. Such gases include oxygen and essentially any gas containing an oxygen atom (e.g. NOₓ) as long as its recombination potential is higher than the formation of ZnO as this gas will be dissociated and ionized under the source.

Oxygen is the preferred oxidising gas and the oxygen content preferably ranges from <10% to >90% by weight. Other gases in the mixture can include the assistive gases such as Ar, N₂ and H₂.

In one case, as an illustrative example, the gas mixture is air and ˜18% by weight of Ar with trace of water vapor from the humid air.

### c) Conditions/Apparatus:

Apparatus used to facilitate the process of the invention will require a high temperature heat source which includes but is not limited to gas-fuel combustion, plasma, hotbox, electrical arc etc so long as evaporation of metallic zinc is possible. One preferred arrangement uses plasma torches as the heat source. In this preferred arrangement the process gases are also part of the heating gases and they are part of the plasma discharge.

At a minimum, to evaporate metallic zinc powder, the source temperature needs to be >1,200° K. The duration of heating depends on the powder size of the zinc. For example, at this temperature, it would take less than a second for a powder size of ˜10 μm to be completely evaporated. The produced zinc oxide powder size may also be large.

In the preferred arrangement, the temperature of the heat source can easily reach >5,000° K, and complete evaporation and reaction time takes <100 msec.

Thus, at this temperature, the zinc almost instantaneously evaporates into zinc vapor. The vapor then reacts with the oxidizing gases (which are part of the plasma gases) and zinc oxide is formed almost instantaneously. The process of the present invention does not require any external heat source to maintain the reaction.

The apparatus includes a reactor. The process of evaporation of metallic zinc will occur within the reactor as well as the chemical reaction with the process gas(es) to form the zinc oxide product. The reactor preferably incorporates the heat source.

In our preferred arrangement our reactor is a single chamber, including the heat source, that carries out material evaporation, chemical reaction, including conversion of any intermediate complex formed to zinc oxide, as well as initial rapid cooling of the zinc oxide powder product. The reactor exit may be connected to an optional nozzle. This can be used (optionally) to further quench or stop growth of the zinc oxide particles, to control their particle size.

Product powder is collected after reaction. In our preferred apparatus this occurs in a collection chamber through physical filtering.

We have previously disclosed apparatus suitable for preparation of nanoscale zinc oxide according to the method of the invention as one embodiment in our Singapore patent application 200400806-8, the contents of which are incorporated herein by reference.

### d) The Process/Reaction:

The process is a preferably a continuous production process whereby metallic zinc is evaporated and reacted with the process gases to form the zinc oxide powder product. Without wishing to be bound by any particular theory we believe that the reaction may well proceed via an intermediate in the form of a zinc hydroxylnitride complex.

We believe that if this complex is formed further heat treatment of this complex occurs leading to whisker or legged structure ZnO product. This heat treatment occurs due to the residual heat from the heat source within the reactor.

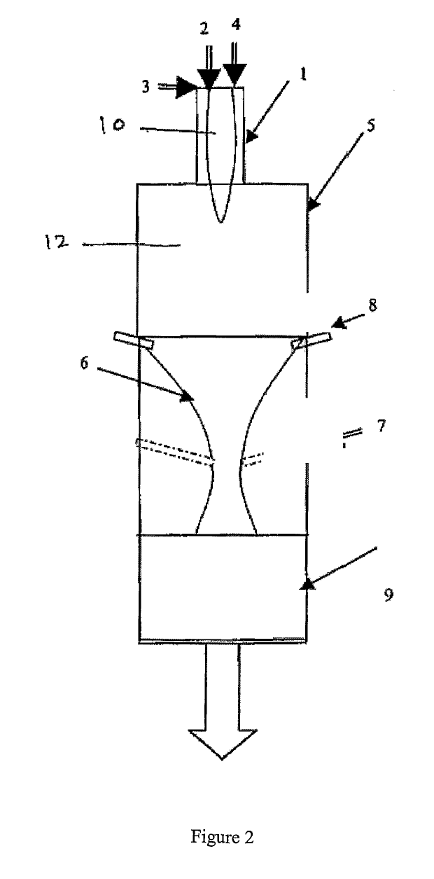

FIG. 1 illustrates a schematic flow diagram of the process of the invention and FIG. 2 illustrates apparatus suitable for facilitating the method of the invention.

With reference to FIGS. 1 and 2 the preferred embodiment of the method of the present invention comprises the steps of first feeding metallic zinc and a first process gas simultaneously into a heating region 10 of a reactor 5. The metallic zinc and the first process gas are fed into the reactor by first passing through same or different feeders 2 and 4 respectively into a heating region 10 of the reactor.

The heat source 1 includes but is not limited to gas-fuel combustion, plasma torch, hotbox, electrical arc, etc. As mentioned previously, in the preferred form, the reactor includes the heat source 1 which is a plasma torch with a temperature of more than 5,000° K.

In one preferred embodiment two process gases are used. One process gas preferably contains at least an inert gas such as argon as an assistive gas that aids in maintaining the plasma discharge in the case where a plasma torch is used as the heat source. It is envisaged that other process gases may also be employed when a different heat source is adopted. In one preferred form, the process gas is compressed air which contains approximately 12 to 22% by weight of argon.

Almost simultaneously, a second process gas containing at least one oxidizing gas such as oxygen is introduced through a second/third feeder 3 and also through the heating region 10. The oxygen content in the second process gas preferably is in the range of 10% to 90% by weight.

In other embodiments the process gas streams are combined. The advantage of separating out the process gases is that the gases are fed through different feeding routes, which allows prevention of source wall over-heating during long hours of continuous operation ie part of the process gas is used as a barrier to maintain the wall at desired temperature and also to prevent the wall from releasing impurities. The first and second process gases can be the same gas.

The first and second process gases form part of heating gases from the heat source 1. They are part of the plasma discharge from the plasma torch in the case where a plasma torch is used.

Upon passing through the heating region 10, the high temperature from the heat source 1 vaporises the metallic zinc almost instantaneously. Under these circumstances, vaporisation of metallic zinc is almost complete. The flow through the heating region 10, which in the preferred embodiment is a plasma source energy region, delivers the then converted vaporised metallic zinc from the plasma source energy region 10 into the reaction region 12 within the reactor 5.

The second process gas which is also part of the plasma discharge is extremely active under the high temperature conditions. It reacts with the zinc vapor formed therefrom to form zinc oxide when the zinc vapor travels from the plasma source energy region 10 into the reaction region 12. Oxidation of the zinc vapor to form zinc oxide continues when both the second process gas and the zinc vapor are in the reaction region 12. The high temperature from the plasma torch allows almost complete oxidation of the zinc vapor to take place within the reaction region 12.

It is worth noting that the reaction (involving evaporation and oxidization) is started and completed in between regions 10 and 12. Theoretically, these processes should be sequential, i.e. vaporization followed by oxidation. But in reality, due to the small volume and dynamic condition, it is almost impractical to distinguish, spatially, these processes.

The process gases flow at a speed of more than 10 m³/hr and preferably more than 15 m³/hr.

Following reaction to form zinc oxide, the “just formed” zinc oxide will undergo rapid cooling in an expansion or cooling region in the reactor. The cooling or expansion region may be physically in either the same or an adjacent location to the reaction region 12. It will be appreciated that when the plasma generated by the plasma torch expands, it will also cool down and the cooling rate may be extremely rapid; this is because in the preferred process of the present invention there is no external heating or confinement to prevent the plasma cooling. The cooling rate is preferably more than 10⁴ K/sec, and is preferably more than 5×10⁴ K/sec. The rapid cooling enables the process to achieve nanoscale zinc oxide powder with a high production rate.

In one form, the reactor exit may be connected to a downstream converging/diverging nozzle 6. The zinc oxide formed in the reaction region 12 passes through the converging/diverging nozzle 6 and the flow is quenched. The main purpose of the converging/diverging nozzle 6 is to further quench the zinc oxide product and stop the growth of zinc oxide particles, thereby controlling the particle size. Note that the use of the nozzle 6 is optional. Nanoscale zinc oxide is also formed without the use of this quenching nozzle, however its presence does allow us to further control the characteristics of the product.

Downstream from the convergent/divergent nozzle 6, there is provided a cooling chamber 9. The cooling chamber 9 is also a collection chamber for collecting the almost cooled zinc oxide form after passing through the convergent/divergent nozzle 6. The zinc oxide powder is collected in the collection chamber through physical filtering. Other suitable methods can also be adopted. The zinc oxide powder is extracted from the collection chamber by auxiliary pump for packaging.

In this system, no external heater is required to provide heat source or to maintain the desired temperature of the system for complete vaporization, oxidation/reaction processes to take place. In the preferred form, the reactor 5 is a single chamber that carries out material vaporization, oxidation/chemical reaction of the materials, including conversion of any intermediate complex formed (such as zinc hydroxylnitride) to zinc oxide. The high temperature from the plasma torch 1 is sufficient to maintain the temperature of the reactor 5. It eliminates the need to use several heaters for different stages of the processes.

The process disclosed herewith is a continuous process instead of a batch process. It permits mass production of nanoscale zinc oxide powder, preferably of a quantity of more than 6 kg/hr and with a relatively small reactor volume, preferably less than 28 litres. This process allows direct feeding of the process materials, both solid and gases, without the need for any materials pretreatment before feeding the materials into the reactor.

### ZnO Product

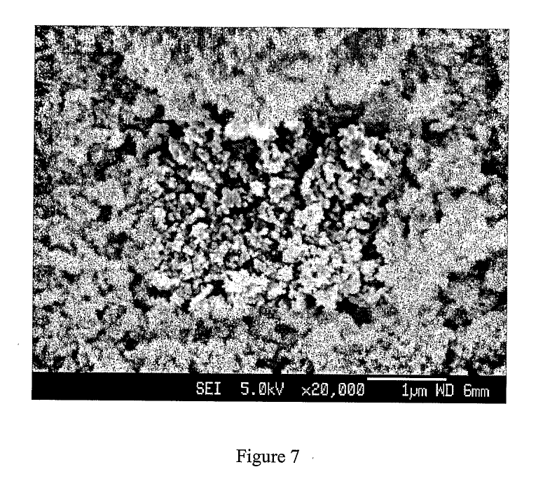

With the method of the invention we are able to produce zinc oxide powder of different morphologies, by altering one or more of the operating parameters, in particular the temperature profile and composition of the gases. For example, when the oxidizing gas contains greater than about 90% by weight oxygen and when the process is carried out at the lower end of plasma energy, zinc oxide having a predominantly 0-D morphology may be obtained, as shown in FIG. 7. On the other hand, if the oxidizing gas contains a lower oxygen content (such as between about 10% and 60% by weight), a mixture of 1-D and 3-D structures may be obtained. It is generally preferred to produce such 1-D and/or 3-D structures.

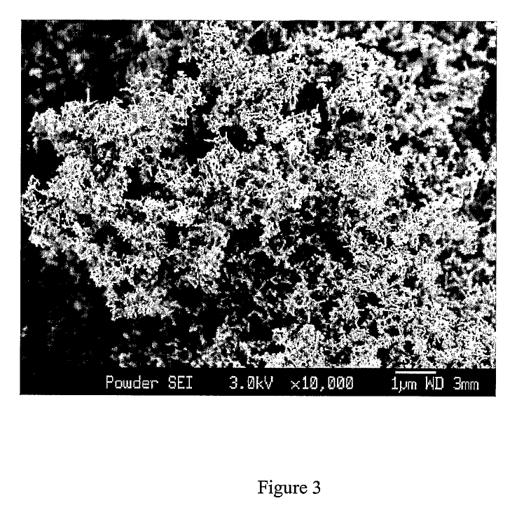

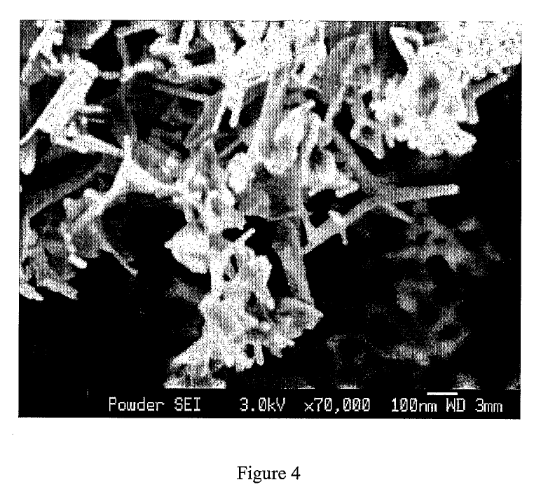

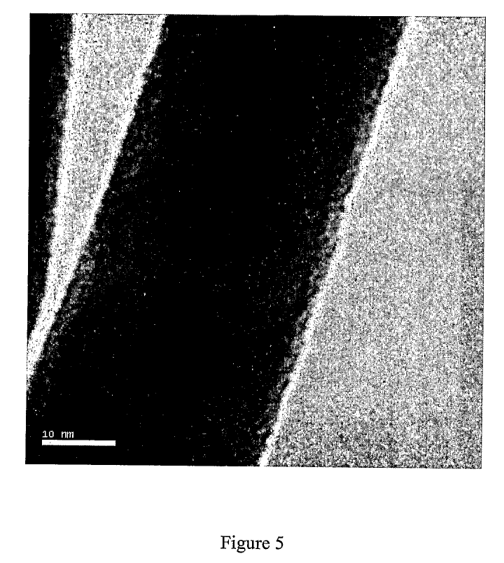

Thus the preferred form of the invention relates to a method of producing multidimensional structured nanoscale zinc oxide powder. By multidimensional we mean a powder with morphology and structure other than 0-dimensional (0-D). This includes 1-D (rods with thin diameter for example); 2-D (very thin plates and discs for example); and 3-D. The zinc oxide powder preferably has a 1-dimensional structure such as whisker and rod structure, and/or of 3-dimensional structure such as tetrapod or multi-legged structure. FIGS. 3 and 4 illustrate examples of zinc oxide whiskers and tetrapods produced from this process, whilst FIG. 5 illustrates one of the legs of the 3-dimensional structure under transmission electron microscope.

The zinc oxide powder product produced by the method of the present invention is preferably in the form of particles having an average diameter of 20-30 nm and an average length of 200-300 nm. Typically if the particle has the structure of a rod (1-D), the diameter ranges between 10-50 nm and its length is between 50-500 nm. If the particles have the structure of tetrapods (3-D), the diameter of one of leg ranges 10-50 nm and the overall structure size is 200-1000 nm.

### Experimental

While the invention has been described with reference to preferred embodiments, it is not to be construed as being limited thereto. Moreover, where specific steps or materials have been referred to, and equivalents are known to exist thereto, such equivalents are incorporated herein as if specifically set forth.

Although the invention has been described by way of example and with reference to particular embodiments, it is to be understood that modifications and/or improvements may be made without departing from the scope or spirit of the invention.

In addition, where features or aspects of the invention are described in terms of Markush groups, those skilled in the art will recognise that the invention is also thereby described in terms of any individual member or subgroup of members of the Markush group.

What is claimed is:

1. A method of preparing nanostructured zinc oxide powder comprising or including the steps of:
a. introducing a source of zinc selected from metallic zinc or a zinc compound and a process gas mixture which includes an oxidising gas (the reactants) into a reactor,
b. while in the reactor, heating the reactants to a process temperature effective to vaporise the zinc and to react the reactants to form a powder product, and
c. recovery of the powder product.

2. A method as claimed in claim 1 wherein the method is a continuous process.

3. A method as claimed in claim 1, wherein the process temperature is in the range 1200 K to 10,000 K.

4. A method as claimed in claim 3 wherein the process temperature is in the range of 1,500 K-3,800 K.

5. A method as claimed in claim 1, wherein the source of zinc is metallic zinc.

6. A method as claimed in claim 5 wherein the metallic zinc is selected from one or both of powdered zinc or zinc wire.

7. A method as claimed in claim 6 wherein the metallic zinc is zinc powder and with an average particle size of between 1 mm to 1 micron.

8. A method as claimed in claim 7 wherein the metallic zinc powder has an average particle size of substantially 5 microns.

9. A method as claimed in claim 8 wherein the average zinc powder particle size is substantially 5 microns.

10. A method as claimed in claim 1, wherein the oxidising gas contains at least an atom of oxygen, and its recombination potential is higher than the formation of ZnO.

11. A method as claimed in claim 10 wherein the oxidising gas is oxygen

12. A method as claimed in claim 11 wherein the oxidising gas comprises between 5% and 95% by weight of the process gas mixture.

13. A method as claimed in claim 12 wherein the oxidising gas comprises between 10% and 60% by weight of the process gas mixture.

14. A method as claimed in claim 1, wherein the process gas mixture may include one or more of an inert gas and an assistive gas.

15. A method as claimed in claim 14 wherein the process gas mixture, in addition to oxygen, includes argon and nitrogen and hydrogen.

16. A method as claimed in claim 15 wherein the process gas mixture includes argon and air.

17. A method as claimed in claim 1 wherein a heat source is used to heat the reactants to the process temperature.

18. A method as claimed in claim 17 wherein the reactor includes the heat source.

19. A method as claimed in claim 17, wherein the heat source is selected from one of gas-fuel combustion heat source, plasma heat source, hotbox, electrical arc.

20. A method as claimed in claim 19 wherein the heat source is a plasma torch having one or more feed gas(es) and one or more plasma discharge gas(es), and one or more of the gases in the process gas mixture is at least a component of the one or more feed gas(es) and one or more plasma discharge gas(es) of the plasma torch.

21. A method as claimed in claim 1, wherein vaporisation of the zinc, reaction of the reactants and initial cooling of the zinc oxide powder product all take place in a single reactor chamber.

22. A method as claimed in claim 21 wherein the reactor chamber includes an initial heating region where vaporization of zinc occurs, a chemical reaction region where reaction of the reactants occurs to form zinc oxide, and a region where the zinc oxide powder product is cooled rapidly.

23. A method as claimed in claim 1, wherein the recovery step includes filtering of the powder product and/or further cooling of the powder product.

24. A method as claimed in claim 1, wherein the method includes a quenching step prior to the recovery step, which slows or stops the growth of the size of the particle product.

25. A method as claimed in claim 1, wherein at least one dimension of the particle product has an average size between 10-3,000 nm.

26. A method as claimed in claim 25 wherein at least one dimension of the particle product has an average size between 10-800 nm.

27. A method as claimed in claim 1, wherein the morphology of the powder product is one or more of sphere-like-, rod-, plate- and multi-legged-dimensional.

28. A method as claimed in claim 27 wherein the morphology of the powder product can be altered by alteration of one or more of the operating parameters of the process.

29. A method as claimed in claim 28 wherein the operating parameters include one or more of:
a. identity of the process gas(es),
b. the power of the heat source,
c. the temperature of the heat source,
d. the process temperature,
e. the identity of the heat source,
f. the rate of cooling of the powder product.

30. A method according to claim 1, wherein the oxidizing gas comprises between 10% and 60% by weight of the process gas mixture and the morphology of the nanostructured zinc oxide powder product is one or more of rod- and multi-legged-dimensional.

31. Nanostructured zinc oxide powder prepared according to a method comprising:
a. introducing a source of zinc selected from metallic zinc or a zinc compound and a process gas mixture which includes an oxidising gas (the reactants) into a reactor,
b. while in the reactor, heating the reactants to a process temperature effective to vaporise the zinc and to react the reactants to form a powder product, and
c. recovery of the powder product.
